(19) United States
(12) Patent Application Publication
(10) Pub. No.: US 2011/0231834 A1
(43) Pub. Date: Sep. 22, 2011

(54) DEVICE AND METHOD FOR PROVIDING FIRMWARE UPDATE SERVICE

(75) Inventor: June-Yeob KIM, Daegu (KR)

(73) Assignee: SAMSUNG ELECTRONICS CO., LTD., Gyeonggi-Do (KR)

(21) Appl. No.: 13/048,111

(22) Filed: Mar. 15, 2011

(30) Foreign Application Priority Data
Mar. 16, 2010 (KR) 10-2010-0023495

(51) Int. Cl. G06F 9/44; G06F 15/16

(52) U.S. Cl. 717/173

(57) ABSTRACT

A method and apparatus for providing a firmware update service, by which a Firmware Over-The-Air (FOTA) service can be efficiently provided. The device preferably includes a server for, upon start of the firmware update service, transmitting battery information and time information required for downloading and updating a delta file to a portable terminal and transmitting the delta file to the portable terminal at the request of the portable terminal. The portable terminal checks a battery capacity for downloading and updating the delta file through the battery information regarding an amount of required capacity for successfully downloading and/or executing the update, and the time information received from the server before downloading and updating the delta file, and displaying a time for downloading and updating the delta file.

### CLAIM OF PRIORITY

This application claims the benefit of priority under 35 U.S.C. §119(a) from Korean Patent Application Serial No. 10-2010-0023495, filed in the Korean Intellectual Property Office on Mar. 16, 2010, the entire disclosure of which is hereby incorporated by reference in its entirety.

### BACKGROUND OF THE INVENTION

1. Field of the Invention

The present invention relates generally to an apparatus and method for providing a firmware update service. More particularly, the present invention relates to an apparatus and method for providing a firmware update service, by which a Firmware Over-The-Air (FOTA) can be efficiently serviced.

2. Description of the Related Art

Currently, portable terminals wirelessly download a path for improving performance and for fixing a fatal defect and update firmware through a Firmware Over-The-Air (FOTA) service.

Through the FOTA service, a user of a portable terminal can update firmware of the portable terminal over the air without visiting an After-Sales (A/S) center. FIG. 1 shows a basic concept of the FOTA service.

When firmware is updated in a wired manner such as by using a Universal Serial Bus (USB), the entire updated file is downloaded in the portable terminal.

However, when firmware is downloaded in a wireless manner, downloading the entire update file as in case of the wired update is possible, but is very inefficient. For efficiency, the FOTA uses an update package (delta file) which is generated by extracting a difference between the original file and the update file, and a series of processes of downloading the delta file in the portable terminal and performing an update operation that follows a standard, Firmware Update Management Object (FUMO), established in the Open Mobile Alliance (OMA). FIG. 2 schematically shows an architecture of the FUMO.

The FOTA service procedure can roughly include five steps as described below, and prior to Step 3 (the Update Package Download) and Step 4 (the Update Package Installation), it is checked as to whether the remaining battery capacity of the portable terminal is sufficient to complete the update operation.

In particular, once the update operation starts in the portable terminal, none of the functions of the portable terminal, including an urgent call, cannot be accessed. Even battery charging through a power connection is not possible. Therefore, if the battery is discharged to the point of rendering the portable terminal inoperable during the update operation, the user may have to visit the A/S center in a worst-case scenario. This type of situation distorts the essence of the object of the FOTA service. Therefore, in the FOTA service procedure, the process of checking the remaining battery capacity is very important prior to undertaking an update function.

An example of a FOTA service procedure can include:
1. Firmware Update Initiation;
2. Device Information Exchange;
3. Update Package Download;
4. Update Package Installation;
5. Notification of Firmware Update.

To solve the aforementioned problems, with regard to the FOTA service procedure, prior to Step 3 (Update Package Download) and Step 4 (Update Package Installation), the remaining battery capacity of the portable terminal is checked based on a particular fixed value. The fixed value is determined by considering the size of the maximum delta file or the battery capacity necessary for updating the maximum delta file, that is, a possible maximum value, to ensure there is not a power loss during update.

For example, if the size of a supportable maximum delta file is 10 Mbytes and the maximum remaining battery capacity necessary for downloading or updating is 50%, the delta file can be downloaded and updated only when the remaining battery capacity is more than 50%, even though the FOTA service can be provided through a delta file of 1 Kbytes with a remaining battery capacity of 5%.

Moreover, while the time required for downloading and updating the delta file varies from size to size of the delta file, but in the conventional portable terminal, such time information regarding downloading and updating is not provided thereto, such that it is not possible to deliver accurate time information required for downloading and updating the delta file to the user.

### SUMMARY OF THE INVENTION

Accordingly, an exemplary aspect of the present invention is to provide a method and apparatus for providing a firmware update service, by which the remaining battery capacity of a portable terminal for downloading and updating a delta file can be flexibly checked a firmware update service process.

Another exemplary aspect of the present invention is to provide a method and apparatus for providing a firmware update service, by which time information required for downloading and updating a delta file can be provided to a user in a firmware update service process.

According to an exemplary aspect of the present invention, there is provided a device for providing a firmware update service. The device preferably includes a server for, upon start of the firmware update service, transmitting battery information and time information required for downloading and updating a delta file to a portable terminal and transmitting the delta file to the portable terminal at the request of the portable terminal. The portable terminal checks a battery for downloading and updates the delta file through the battery information and the time information received from the server before downloading and updating the delta file, and displays a time for downloading and updating the delta file.

According to another exemplary aspect of the present invention, there is provided a method for providing a firmware update service. The method preferably includes a server transmitting to a portable terminal, upon start of the firmware update service, battery information and time information required for downloading and updating a delta file. The portable terminal checks a battery for downloading the delta file and displays a time required for downloading the delta file through the battery information and the time information required for downloading the delta file, upon downloading the delta file received from the server in the portable terminal. The portable terminal also checks a battery for updating the delta file and displaying a time for updating the delta file through the battery information and the time information required for updating the delta file, and then the portable terminal updates the delta file.

### BRIEF DESCRIPTION OF THE DRAWINGS

The above and other exemplary features and advantages of exemplary aspects of the Device and Method for Providing Firmware Update Service according to the present invention will become more apparent from the following detailed description taken in conjunction with the accompanying drawings, in which:

FIG. 1 is a diagram that describes a basic concept of an FOTA service;

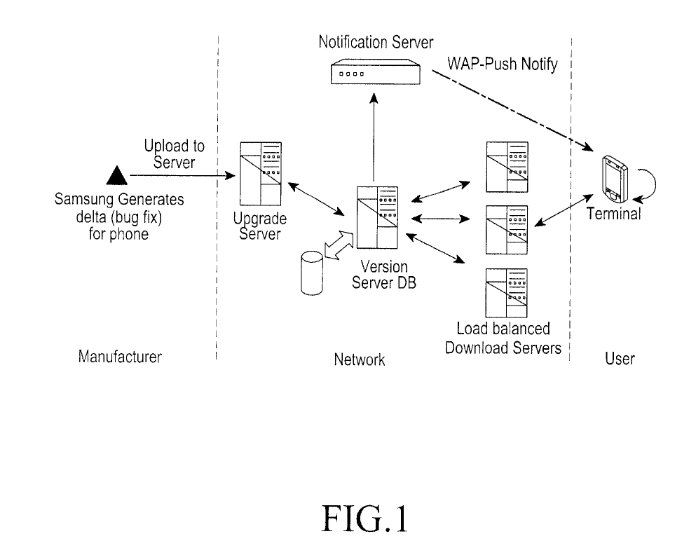

FIG. 2 is a diagram schematically showing an architecture of a conventional FUMO service;

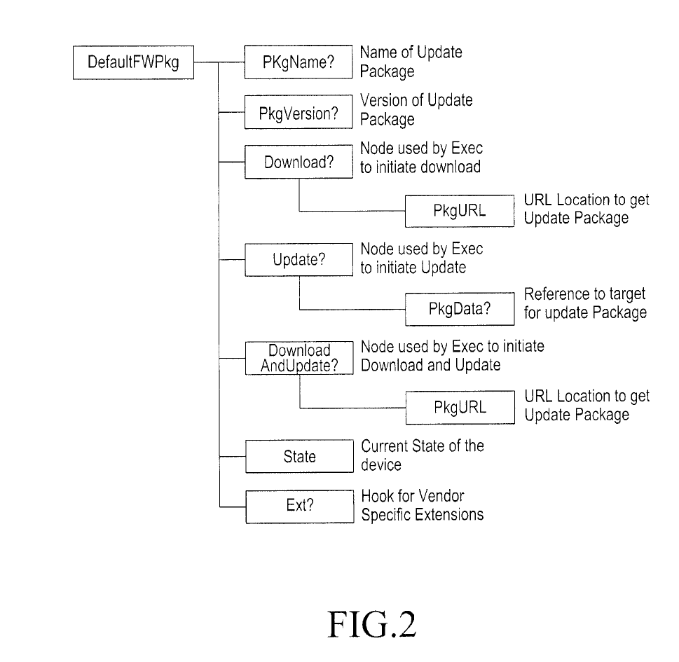

FIG. 3 is a diagram schematically showing an architecture of a FUMO according to an exemplary embodiment of the present invention;

FIG. 4 is a block diagram of a portable terminal according to an exemplary embodiment of the present invention; and

FIG. 5 is a flowchart illustrating a firmware update service process according to an exemplary embodiment of the present invention.

### DETAILED DESCRIPTION

Hereinafter, one or more exemplary embodiment(s) of the present invention will be described in detail with reference to the accompanying drawings for illustrative purposes and not to limit the appended claims. The claimed invention is in no way limited to the examples shown and described herein. It should be noted that identical components are referred to as identical symbols throughout the drawings.

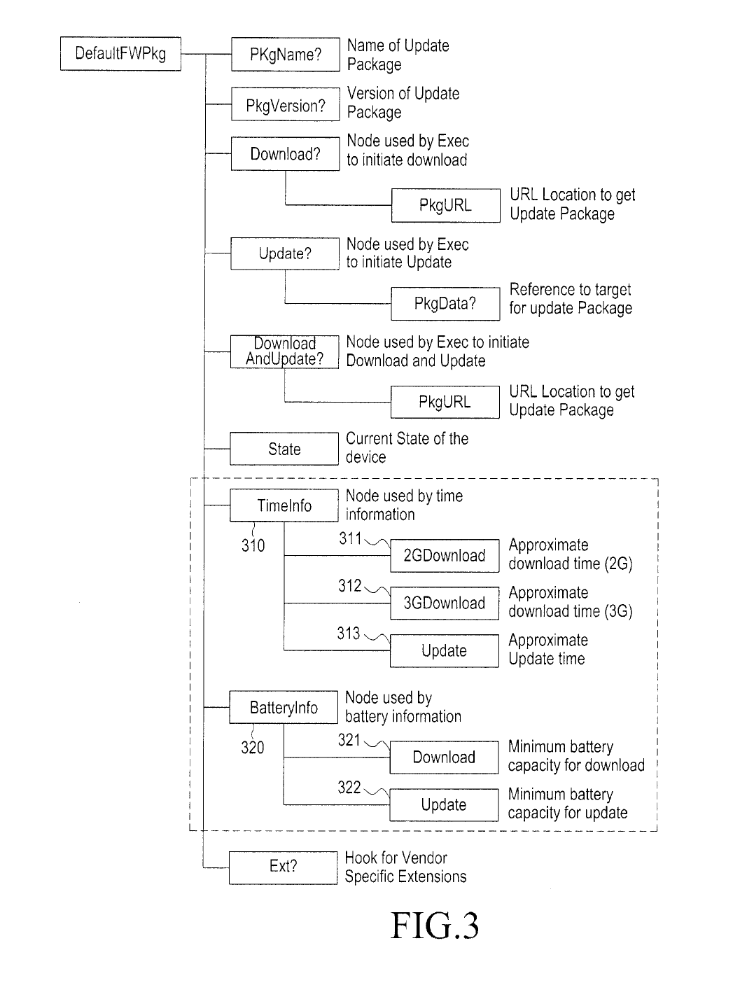

FIG. 3 is a diagram schematically showing an architecture of a Firmware Update Management Object (FUMO) according to an exemplary embodiment of the present invention.

In FIG. 3, a time information node and a battery information node work in concert with a FUMO architecture. The time information node 310 stores time information required for downloading and updating a delta file, and the time information node 310 includes a 2^{nd}-generation (2G) time information download node 311 and a 3^{rd}-generation (3G) time information download node 312, which are at least one time information download nodes, and a time information update node 313, as its subsidiary nodes.

Still referring to FIG. 3, the 2G time information download node 311 stores time information required for downloading a delta file in a 2G network. The 3G time information download node 312 stores time information required for downloading a delta file in a 3G network. The time information update node 313 stores time information required for updating the delta file.

In addition, the battery information node 320 stores battery information required for downloading and updating the delta file, and preferably includes a battery information download node 321 and a battery information update node 322 as its subsidiary nodes.

The battery download node 321 stores battery information of the portable terminal required for downloading the delta file, and the battery information update node 322 stores battery information of the portable terminal required for updating the delta file.

The FUMO architecture as shown in FIG. 3 is preferably stored both in a server (not shown) and the portable terminal.

The server has the FUMO architecture as shown in FIG. 3, and provides a firmware update service to the portable terminal through the FOTA service.

In the case where an update file exists, the server generates a delta file by extracting a difference between the original file and the update file, generates battery information and time information required for downloading and updating the delta file, and transmits the battery information and the time information to the portable terminal.

Thereafter, if the delta file is requested by the portable terminal, the server transmits the delta file to the portable terminal.

The portable terminal has the FUMO architecture as shown in FIG. 3, and performs the firmware update service function through the FOTA service.

Prior to downloading and updating of the delta file in the firmware update process, the portable terminal flexibly checks its remaining battery capacity for downloading and updating the delta file through the battery information and the time information received from the server, and provides the time information required for downloading and updating the delta file to the user.

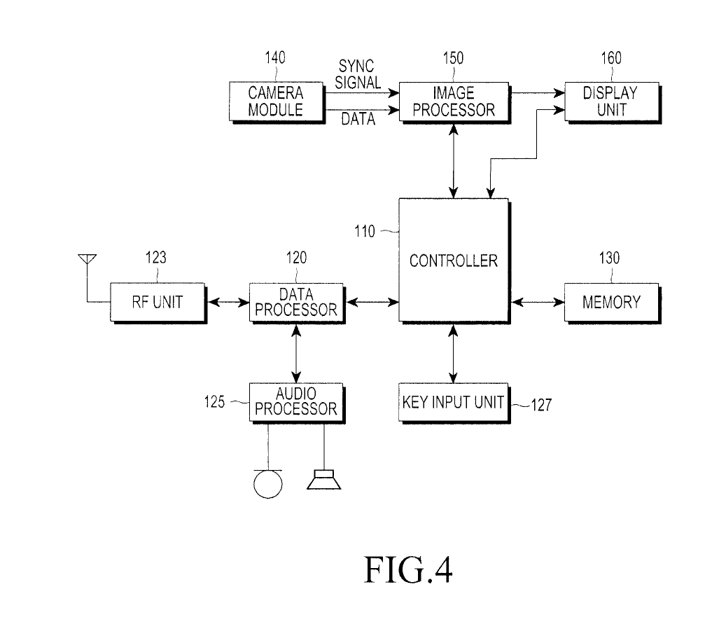

The structure of the portable terminal will now be described in detail with reference to FIG. 4.

Referring to FIG. 4, a Radio Frequency (RF) unit 123 performs a wireless communication function of the portable terminal. The RF unit 123 preferably includes an RF transmitter for up-converting a frequency of a transmission signal and amplifying the transmitted signal and an RF receiver for low-noise amplifying a received signal and down-converting the frequency of the received signal. A data processor 120 includes a transmitter for encoding and modulating the transmission signal and a receiver for demodulating and decoding the received signal. In other words, the data processor 120 may include a modem and a codec.

In this example, the codec preferably includes a data codec for processing packet data and an audio codec for processing an audio signal such as voice. An audio processor 125 reproduces an audio signal being output from the audio codec of the data processor 120 or transmits an audio signal generated from a microphone to the audio codec of the data processor 120.

A key input unit 127 includes keys for inputting numeric and character information and function keys for setting various functions. It is possible that the display unit could have a touch screen function and serve as a key input in addition to or in lieu of the key input unit 127.

A memory 130 preferably includes both program and data memories. The program memory stores programs for controlling a general operation of the portable terminal and programs for controlling a firmware update service in the FUMO architecture according to an embodiment of the present invention. The data memory temporarily stores data generated during execution of the programs. The memory 130 may also store the FUMO architecture as shown in FIG. 3 according to an exemplary embodiment of the present invention.

A controller 110 controls overall operation of the portable terminal. The controller 110, upon receiving the battery information and the time information required for downloading and updating the delta file from the server according to an exemplary embodiment of the present invention, stores the battery information required for downloading the delta file in the battery information download node 321 of the battery information node 320 in the FUMO architecture, and stores the battery information required for updating the delta file in the battery information update node 322 of the battery information node 320.

The controller 110 also stores the time information required for downloading the delta file in the 2G time information download node 311 or the 3G time information download node 312 of the time information node 310 in the FUMO architecture, and stores the time information required for updating the delta file in the time information update node 313 of the time information node 310.

The battery information required for downloading and updating the delta file, stored in the battery information node 320, preferably includes a battery value required for downloading and updating the delta file by the portable terminal.

The time information required for downloading and updating the delta file, stored in the time information node 310, preferably includes a time required for downloading and updating the delta file by the portable terminal.

The controller 110 compares the battery information required for downloading the delta file, stored in the battery information download node 321, with a current remaining battery capacity of the portable terminal according to an embodiment of the present invention.

According to an exemplary aspect of the present invention, if the current remaining battery capacity of the portable terminal is greater than the amount of capacity specified by the battery information required for downloading the delta file, the controller 110 displays the time information required for downloading the delta file on the display unit 160 and requests the delta file from the server.

However, if the current remaining battery capacity of the portable terminal is less than amount of capacity specified by the battery information required for downloading the delta file, the controller 110 displays battery a charging required indicator of the portable terminal on the display unit 160 to inform the user that the battery of the portable terminal needs to be charged. If the current remaining battery capacity of the portable terminal is greater than the battery information required for downloading the delta file after charging of the battery of the portable terminal, the controller 110 displays the time information required for downloading the delta file on the display unit 160 and requests the delta file from the server.

Upon receiving the delta file from the server, the controller 110 downloads the delta file in the memory 130 and compares the battery information required for updating the delta file, stored in the battery information update node 322, with the current remaining battery capacity of the portable terminal. If the current remaining battery capacity of the portable terminal is greater than the amount specified in the battery information required for updating the delta file, the controller 110 displays the time information required for updating the delta file on the display unit 160 and updates the delta file in the portable terminal.

However, if the current remaining battery capacity of the portable terminal is less than the amount specified in the battery information required for updating the delta file, the controller 110 displays battery charging of the portable terminal on the display unit 160 to inform the user that the battery of the portable terminal needs to be charged.

If the current remaining battery capacity of the portable terminal is greater than the amount specified in the battery information required for downloading the delta file after charging of the battery of the portable terminal, the controller 110 displays the time information required for updating the delta file on the display unit 160 and updates the delta file in the portable terminal.

With continued reference to FIG. 4, a camera module 140 captures an image, and the module 140 may include a camera sensor for converting an optical signal of the captured image into an electrical signal, and a signal processor for converting an analog image signal of the image captured by the camera sensor into digital data. Herein, it is assumed that the camera sensor is preferably a Charge Coupled Device (CCD) sensor or a Complementary Metal Oxide Semiconductor (CMOS) sensor, and the signal processor may be implemented as a Digital Signal Processor (DSP). In addition, the camera sensor and the signal processor may be implemented as one piece or separately.

An image processor 150 performs Image Signal Processing (ISP) in order to display an image signal output from the camera module 140 on the display unit 160. The ISP executes functions such as gamma correction, interpolation, space conversion, image effect, image scale, Auto White Balance (AWB), Auto Exposure (AE) and Auto Focus (AF). Thus, the image processor 150 processes the image signal output from the camera module 140 in the unit of a frame, and outputs frame image data adaptively to the features and size of the display unit 160. The image processor 150 includes an image codec, and compresses the frame image data displayed on the display unit 160 in a preset manner or restores the compressed frame image data to the original frame image data. Herein, the image codec may be Joint Picture Experts Group (JPEG) codec, Moving Picture Experts Group 4 (MPEG4) codec, or Wavelet codec. It is assumed that the image processor 150 has an on screen display (OSD) function. The image processor 150 may output OSD data according to the displayed picture size under the control of the controller 110.

The display unit 160 displays an image signal output from the image processor 150 on the screen and displays user data output from the controller 110. Herein, the display unit 160 may be comprised of, for example, a Liquid Crystal Display (LCD), and in this case, the display unit 160 may include an LCD controller, a memory capable of storing image data, an LCD element, and so on. When the LCD is implemented with a touch screen, it may serve as an input unit. In addition, any other type of thin-film screen technology can be used. The display unit 160 displays battery charging in the firmware update service process according to an exemplary embodiment of the present invention if the current remaining battery capacity of the portable terminal is less than the amount specified by battery information required for downloading and updating the delta file.

The display unit 160 displays the time information required for downloading and updating the delta file in the firmware update service process according to an exemplary embodiment of the present invention.

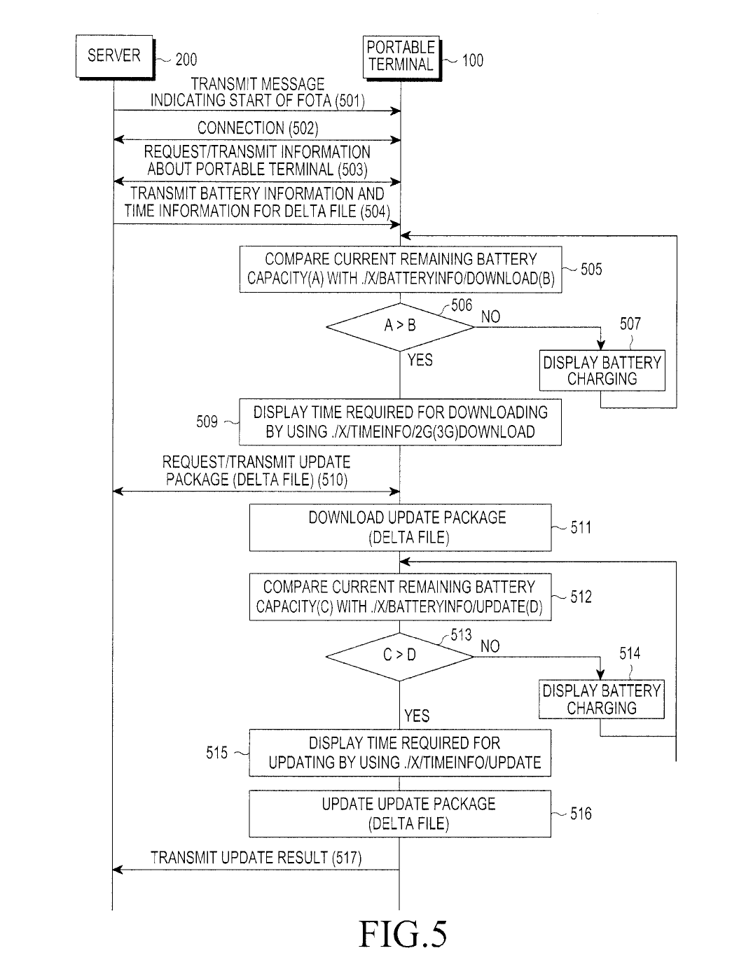

Now, with reference to FIG. 5, a description will now be made of the firmware update service process between the portable terminal and the server.

FIG. 5 is a flowchart illustrating the firmware update service process according to an exemplary embodiment of the present invention.

The exemplary embodiment will be described in detail with reference to FIGS. 3 and 4 together.

Referring now to FIG. 5, if an update file exists, a server 200 generates a delta file by extracting a difference between the original file and the update file and generates battery information and time information of a portable terminal 100 required for downloading and updating the delta file.

At step 501, the server 200 transmits a message indicating the start of an FOTA service to the portable terminal 100 in step.

Upon receiving the message indicating the start of the FOTA start from the server 200, at step 502 the controller 110 of the portable terminal 100 senses the reception and connects to the server 200 automatically or at the request of the user.

Once the server 200 and the portable terminal 100 are connected in step 502, at step 503 the server 200 requests information about the portable terminal 100 from the portable terminal 100. Also in step 503, the portable terminal 100 transmits the information about the portable terminal 100, such as software (S/W) version information, to the server 200.

At step 504, based on the information about the portable terminal 100 received from the portable terminal 100, the server 200 checks whether the portable terminal 100 is a target to which the delta file is destined, and transmits both the battery information and the time information required for downloading and updating the delta file to the portable terminal 100.

Upon receiving in step 504 the battery information and the time information required for downloading and updating the delta file from the server 200, the controller 110 stores the battery information required for downloading the delta file in the battery information download node 321 of the battery information node 320 in the FUMO architecture as shown in FIG. 3, and the battery information required (such as an amount of battery capacity typically required) for updating the delta file in the battery information update node 322 of the battery information node 320. The controller 110 stores the time information required for downloading the delta file in the 2G time information download node 311 or the 3G time information download node 312 of the time information node 310, and the time information required for updating the delta file in the time information update node 313 of the time information node 310.

In step 505, thereafter, the controller 110 compares a current remaining battery capacity A of the portable terminal 100 with battery information regarding an amount of capacity B required for downloading the delta file, which has been stored in the battery information download node 321.

In step 506, if the current remaining battery capacity A is not greater than the battery information regarding the amount of capacity B, the controller 110 senses the result and at step 507 displays battery charging on the display unit 160 that recommends the user should charge the battery of the portable terminal 100 prior to downloading the update package.

After the battery of the portable terminal 100 is charged or if the current remaining battery capacity A is greater than the battery information capacity B in step 506, the controller 110 senses the result and at step 509 displays the time information required for downloading the delta file on the display unit 160.

In step 509, the controller 110 displays the time information required for downloading the delta file on the display unit 160 by using the time information required for downloading the delta file, which has been stored in the 2G time information download node 311 or the 3G time information download node 312.

In step 510, after or when the time information required for downloading the delta file is displayed on the display unit 160, the controller 110 requests the delta file from the server 200.

Upon receiving the delta file from the server 200 at the request of the portable terminal 100, at step 512 the controller 110 compares a current remaining battery capacity C of the portable terminal 100 with battery information regarding the amount of capacity D required for updating the delta file, which has been stored in the battery information update node 322.

At step 513, if the current remaining battery capacity C is not greater than the battery information regarding the amount of capacity D required, the controller 110 senses the result and at step 514 displays a battery charging recommendation on the display unit 160 that recommends to the user to charge the battery of the portable terminal 100 prior updating by executing the update file.

At step 516, after the battery of the portable terminal 100 is charged or if the current remaining battery capacity C is greater than the battery information regarding the amount of capacity D required, the controller 110 senses the result and displays the time information required for downloading the delta file on the display unit 160 in step 516.

In step 516, the controller 110 displays the time information required for updating the delta file on the display unit 160 by using the time information required for downloading the delta file, which has been stored in the time information download node 313.

Once updating of the delta file is completed in the portable terminal 100, at step 517 the controller 110 transmits the update result to the server 200. As can be appreciated from the foregoing description, by providing the device and method for providing the firmware update service, the present invention checks whether the remaining battery capacity of the portable terminal is equal to or greater than a required capacity for downloading and updating the delta file in the firmware update service process, thus actively handling some situation in the service process, and provides time information required for downloading and updating the delta file to the user.

While the present invention has been shown and described with reference to an exemplary embodiment thereof, it will be understood by those skilled in the art that various changes in form and details may be made therein without departing from the spirit and scope of the invention as defined by the appended claims. Therefore, the scope of the present invention should be defined by the appended claims and equivalents thereof, rather than the disclosed exemplary embodiment.

The above-described methods according to the present invention can be realized in hardware, as software, firmware or computer code that can be stored in a recording medium such as a CD ROM, an RAM, a floppy disk, a hard disk, or a magneto-optical disk or downloaded over a network, so that the methods described herein can be rendered in such software using a general purpose computer, microprocessor, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A device for providing a firmware update service, the device comprising:
a server for transmitting to a portable terminal upon start of the firmware update service battery information and time information associated with downloading and updating a delta file to a portable terminal, the server creating the delta file by extracting a difference between an original file and an update file and transmitting the delta file to the portable terminal at the request of the portable terminal; and
the portable terminal for checking a battery capacity required for downloading with an actual battery capacity and updating the delta file through the battery information and the time information received from the server prior to downloading and applying the delta file, and for displaying a projected time in order to download and updating the delta file.

2. The device of claim 1, wherein when receiving the battery information and the time information from the server, the portable terminal displays the time information associated with downloading the delta file and requests the delta file from the server if a current remaining battery capacity of the portable terminal is greater than the battery usage required for downloading the delta file as indicated by the battery information; and displays an indication recommending battery charging of the portable terminal if the current remaining battery capacity of the portable terminal is not greater than the required battery usage indicated in the battery information required for downloading the delta file.

3. The device of claim 2, wherein after the battery charging of the portable terminal is completed according to the display of the battery charging of the portable terminal, if the current remaining battery capacity of the portable terminal is greater than the required battery usage indicated in the battery information for downloading the delta file, the portable terminal displays the time information required for downloading the delta file and requests transmission of the delta file from the server.

4. The device of claim 2, wherein the portable terminal downloads the delta file upon receiving the delta file from the server; displays the time information required for updating the delta file and updates the delta file if the current remaining battery capacity of the portable terminal is greater than the battery information required for updating the delta file; and displays the battery charging of the portable terminal if the current remaining battery capacity of the portable terminal is not greater than the required battery usage indicated in the battery information required for updating the delta file.

5. The device of claim 4, wherein after the battery charging of the portable terminal is completed, if the current remaining battery capacity of the portable terminal is greater than the required battery usage indicated in the battery information required for updating the delta file, the portable terminal displays the time information required for updating the delta file and updates the delta file.

6. The device of claim 1, wherein the battery information required for updating and downloading the delta file comprises a battery value required for downloading and updating the delta file by the portable terminal, and
the time information required for updating and downloading the delta file comprises a time required for downloading and updating the delta file by the portable terminal.

7. The device of claim 1, wherein the server and the portable terminal comprise the same Firmware Update Management Object (FUMO) architecture for providing the firmware update service, and the FUMO architecture comprises a battery information node for storing the battery information required for downloading and updating the delta file and a time information node for storing the time information required for downloading and updating the delta file.

8. The device of claim 7, wherein the battery information node comprises a battery information download node for storing the battery information required for downloading the delta file and a battery information update node for storing the battery information required for updating the delta file.

9. The device of claim 7, wherein the time information node comprises a time information download node for storing the time information required for downloading the delta file and a time information update node for storing the time information required for updating the delta file.

10. A method for providing a firmware update service, the method comprising:
upon start of the firmware update service, transmitting by a server to a portable terminal, battery information and time information required for downloading and updating a delta file;
checking, by the portable terminal, a battery capacity for downloading the delta file and displaying a time required for downloading the delta file through the battery information and the time information required for downloading the delta file;
upon downloading the delta file received from the server in the portable terminal, checking, by the portable terminal, a battery capacity for updating the delta file and displaying a time for updating the delta file through the battery information and the time information required for updating the delta file; and
updating, by the portable terminal, the delta file.

11. The method of claim 10, wherein the displaying of the time required for downloading the delta file comprises:
comparing, by the portable terminal, a current remaining battery capacity of the portable terminal with required battery usage in the battery information required for downloading the delta file; and
if the current remaining battery capacity of the portable terminal is greater than the battery information required for downloading the delta file, displaying a time required for downloading the delta file based on the time information required for downloading the delta file.

12. The method of claim 11, further comprising,
if the current remaining battery capacity of the portable terminal is not greater than the required battery usage in the battery information required for downloading the delta file, displaying a message indicating battery charging of the portable terminal has commenced,
after the battery charging of the portable terminal is completed, comparing the current remaining battery capacity of the portable terminal with the required battery usage in the battery information required for downloading the delta file; and
if the current remaining battery capacity of the portable terminal is greater than the battery information required for downloading the delta file, displaying the time required for downloading the delta file based on the time information required for downloading the delta file.

13. The method of claim 10, further comprising:
after the displaying of the time required for downloading the delta file, requesting, by the portable terminal, the delta file from the server; and
upon receiving the delta file from the server, downloading, by the portable terminal, the delta file.

14. The method of claim 10, wherein the displaying of the time required for updating the delta file comprises:
upon downloading the delta file received from the server in the portable terminal, comparing, by the portable terminal, a current remaining battery capacity of the portable terminal with the required battery usage in the battery information required for updating the delta file; and
if the current remaining battery capacity of the portable terminal is greater than the battery information required for updating the delta file, displaying a time required for updating the delta file based on the time information required for updating the delta file.

15. The method of claim 14, further comprising:
if the current remaining battery capacity of the portable terminal is not greater than the required battery usage in the battery information required for updating the delta file, displaying an indication that battery charging of the portable terminal is occurring,
after the battery charging of the portable terminal is completed, comparing the current remaining battery capacity of the portable terminal with the required battery usage in the battery information required for updating the delta file; and
if the current remaining battery capacity of the portable terminal is greater than the required battery usage in the battery information required for updating the delta file, displaying the time required for updating the delta file based on the time information required for updating the delta file.

16. The method of claim 10, wherein the battery information required for updating and downloading the delta file comprises a battery value required for downloading and updating the delta file by the portable terminal, and
the time information required for updating and downloading the delta file comprises a time required for downloading and updating the delta file by the portable terminal.
